(19) United States
(12) Patent Application Publication
(10) Pub. No.: US 2008/0315621 A1
(43) Pub. Date: Dec. 25, 2008

(54) Trim Panel for the Interior of a Motor Vehicle and a Manufacturing Process for Such a Trim Panel

(75) Inventors: Andreas Alvehav, Kungalv (SE); Bo Olofsson, Vastra Frolunda (SE)

Correspondence Address: WRB-IP LLP, 1217 KING STREET, ALEXANDRIA, VA, 22314, US

(73) Assignee: Volvo Lastvagnar AB, Goteborg (SE)

(21) Appl. No.: 12/097,546

(22) PCT Filed: Dec. 15, 2005
(86) PCT No.: PCT/SE05/01943

§ 371 Date: Aug. 21, 2008

(51) Int. Cl. B60J 5/00; B29C 63/00

(52) U.S. Cl. 296/146.7; 264/241

(57) ABSTRACT

A trim panel for the interior of the cab of a motor vehicle has a first and a second main direction of extension. The trim panel includes a first part and a second part, with the second part being significantly less rigid than the first part in a direction which is essentially perpendicular towards at least one of the directions of extension. The panel includes a continuous carrier made in a first material with a certain first rigidity, and the first part is obtained by letting the carrier material be exposed and visible, and the second part is obtained by means of a second material with a second rigidity covering a part of the carrier. There is a third material with a third rigidity arranged between the first and the second material.

### BACKGROUND AND SUMMARY

The present invention discloses a panel, such as a so called interior trim panel, for the interior of the cab of a motor vehicle such as a truck. The trim panel has a first and a second main direction of extension, and comprises a first part and a second part, with the first part being significantly less rigid than the second part in a direction which is essentially perpendicular towards at least one of said directions of extension.

By means of the panel of the invention, a higher degree of safety than hitherto is achieved, as well as lower production costs.

In the interior of motor vehicles such as, for example, trucks, trim panels are used in a variety of applications. An example of one such application is the instrument panel or dash board of the vehicle, which in this case extends from the area facing the driver down towards the floor of the vehicle.

There is a desire for the upper part of the instrument panel to be smooth and soft to touch, whilst there is usually no such corresponding need for the lower part of the instrument panel. This has led to conventional trim panels, instrument panels among them, to consist of two parts, where one part is made of a soft material, and another part is made of a harder material, with the two parts being joined together.

A trim panel which is designed using two discrete parts which are joined together will have a seam or a joint, which will negatively influence the safety of those travelling in the vehicle, in case of a collision. The negative effect on the safety will, inter alia, be caused by details which are used to join the two parts together, such as screws, washers etc.

Also, the fact that the trim panel consists of more than one part will increase the manufacturing cost, since this will lead to a more expensive manufacturing process

As discussed above, there is a need for a trim panel which can be used, for example, as an instrument panel in a motor vehicle such as a truck, and which provides a higher degree of safety than previous solutions. The panel should also have a simpler manufacturing process than previous such articles, which will lead to also lower manufacturing costs.

This need is addressed by an aspect of the present invention in that it discloses a trim panel for the interior of the cab of a motor vehicle such as a truck, which has a first and a second main direction of extension.

The trim panel comprises a first part and a second part, and the second part is significantly less rigid than the first part in a direction which is essentially perpendicular towards at least one of said directions of extension. The trim panel comprises one continuous carrier made in a first material with a certain first rigidity, and the first part of the trim panel is obtained by letting the carrier material be exposed and visible. The second part of the trim panel is obtained by means of a second material with a second rigidity which covers a part of the carrier, and the trim panel also comprises a third material with a third rigidity which is arranged between the first and the second materials.

Thus, by means of an aspect of the invention, a panel such as an instrument panel can be manufactured using a carrier on at least part of which there is arranged a cover of, for example, skin, foil or fabric, which provides a high degree of comfort and aesthetic effect. Beneath the cover there is arranged a material such as foam, in order to make the second part of the panel even more flexible to the touch.

Those parts of the carrier for which there is no need for the effects given by the cover and its filling are left exposed and visible, perhaps painted or with some kind of pattern, so called “graining”.

The joint or seam between two parts is thus eliminated, which improves the safety, and the panel becomes one article in the manufacturing process, thus lowering the manufacturing cost.

### BRIEF DESCRIPTION OF THE DRAWINGS

The invention will be described in more detail in the following, with the aid of the appended drawings, in which

FIG. 1 shows a front view of a panel according to the invention, and

FIG. 2 shows a front cross sectional view of the panel according to the invention, and

FIGS. 2-11 show steps in the manufacturing of a panel according to the invention.

### DETAILED DESCRIPTION

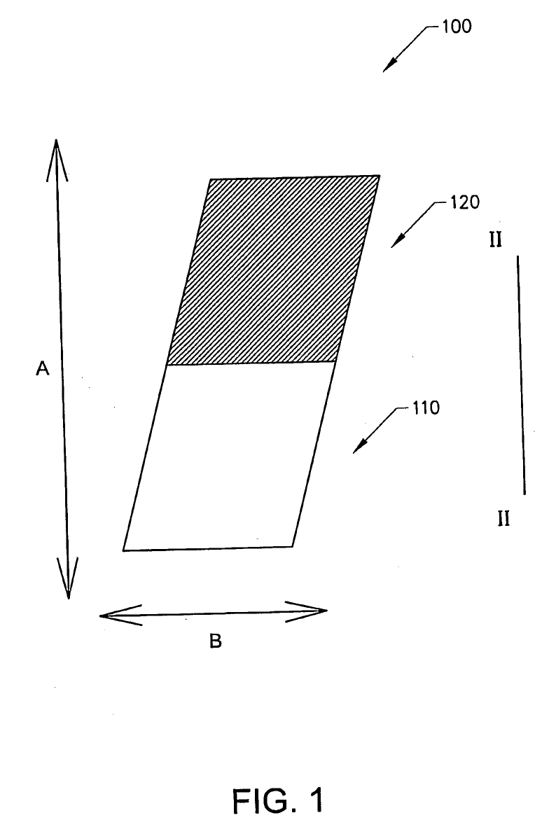

FIG. 1 shows a front view of a trim panel 100 according to the invention. The trim panel 100 is intended for the interior of a cab of a motor vehicle, such as a truck, and one application area for the trim panel is as an instrument panel in the cab. However, the use of the trim panel 100 as an instrument panel is merely an example, the trim panel 100 can be used in a wide variety of other applications, such as, for example, interior door panels of the vehicle.

As is hinted at in FIG. 1, the panel has a first A and a second B main direction of extension, and comprises a first part 110 and a second part 120. As will be elaborated upon later in this text, the second part 120 is significantly less rigid than the first part 110 in a direction which is essentially perpendicular towards at least one of said directions of extension, i.e. a direction which, when the panel is used as an instrument panel, will face the driver or passenger of the vehicle.

The term “instrument panel” in this context is intended to refer to a detail in the vehicle which has one part which is easily accessible to the driver, as well as having one part which extends beneath the part which is accessible to the driver, in the direction of the pedals or the floor of the vehicle.

There are demands for the part of the instrument panel which is easily accessible to the driver to be smooth and flexible to the touch, perhaps with an elegant finish or outer layer. However, that part of the instrument board which extends down towards the pedals or the floor of the vehicle normally has no such demands upon it, i.e. being soft to the touch. Thus, traditionally, panels on which there are such dual demands have been manufactured from at least two parts, one part being a soft part usually consisting of a foam core with a cover of, for example, plastic foil, and the other part consisting of a hard plastic sheet, the two parts being joined to each other by methods such as welding or riveting.

The fact that two or more parts are used to create traditional panels will increase production costs, and also, the fact that there will be a joint or a seam between the two parts will decrease the collision safety of the panel. The decreased safety is caused by, inter alia, the risk of sharp edges between two parts being exposed in the event of a collision.

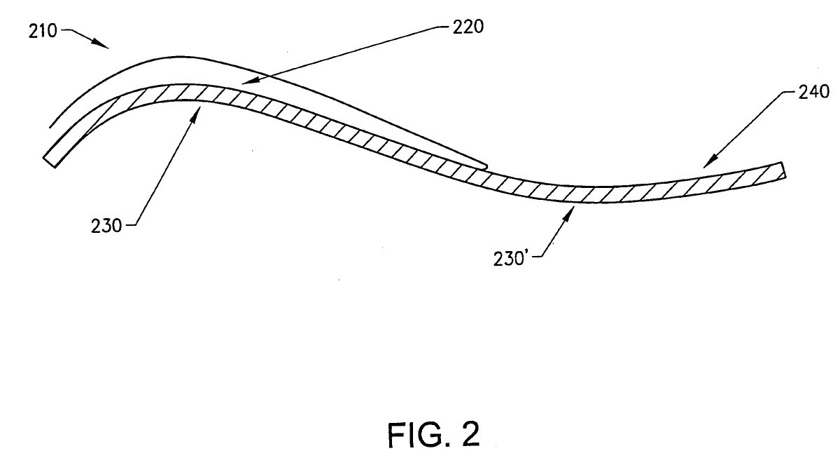

FIG. 2 shows a cross section of a trim panel 200 according to the invention along the line H-II in FIG. 1. As can be seen, the panel 200, in similarity to known panels, comprises a first 240 and a second 210 part, the second part 210 being the part of the trim panel 200 which is intended to be soft to the touch, and the first part 240 being intended to be the part of the trim panel which does not need to be soft to the touch.

As shown in FIG. 2, the panel 200 of the invention comprises one continuous carrier 230, which extends along both the first part 240 and the second part 210. This carrier 230 can be made in a first material such as any suitable thermoplastic polymer, for example PP (Polypropelene) or ABS (Acrylonitrile Butadiene Styrene). Thus, the panel 200 will comprise a carrier 230 with a certain first rigidity, which can be chosen by varying the first material and/or its thickness.

The first part 240 of the panel is obtained by letting the material of a part 230′ of the extension of the carrier 230 be exposed and visible, and the second part 210 of the panel 200 is obtained by using a second material with a second rigidity to cover a part of the carrier.

The second material will thus be the surface of the second part 210, and will face the driver or passenger of the motor vehicle. The second material can suitably be chosen from the following group of materials: skin, leather, or a textile or plastic foil or fabric, which will make the surface of the second part 210 aesthetically pleasant as well as pleasant to touch.

FIG. 2 shows a preferred embodiment of the panel 200: there is arranged a material 220 with a third rigidity between the first and the second material. Suitably, the rigidity of the material 220 is lower than that of the carrier material 200. In a preferred embodiment, the material 220 is a foam material such as, for example, PUR (Polyurethane) foam.

Thus, the design of the trim panel 200 can be said to comprise a hard carrier 230, which supports a “cushion” with a cover material 210 and a filling material 220. By virtue of its design, the trim panel 200 can comprise one single detail in a manufacturing process, and due to the fact that one and the same carrier 230 supports the panel, joints, edges and rivets are eliminated, which increases the safety factor of the trim panel 200.

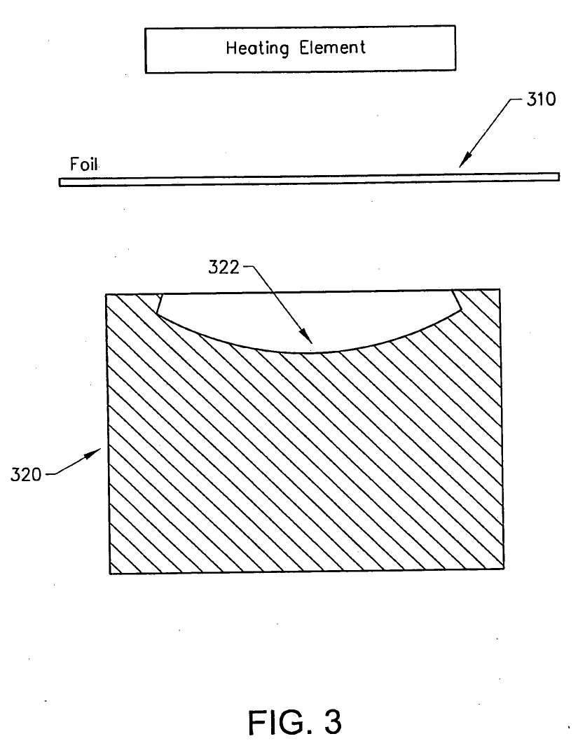

Turning now to the manufacturing process of the trim panel 200, this is illustrated schematically in FIGS. 3-5.

FIG. 3 shows a piece 310 of material such as, for example, plastic foil, which will be used as the “cover” material 210, the piece 310 in FIG. 3 being shown in an “unprocessed” state. FIG. 3 also shows a tool 320 for giving the piece 310 a desired shape. As shown, the tool 320 comprises a section 322 which is shaped in the same form as it is desired to give the foil 210. This piece will, in the proper shape, be cut out of the piece 310, and be used as the cover material 210.

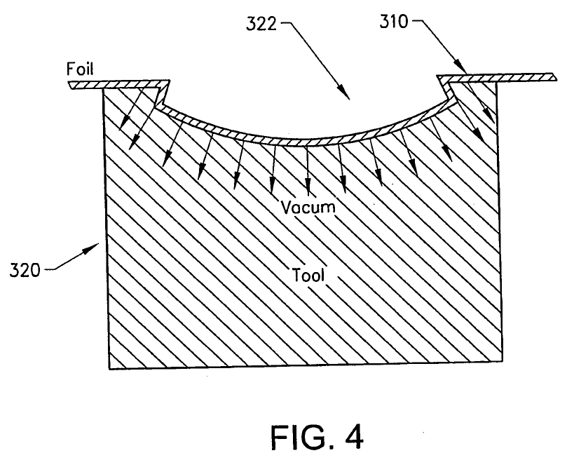

In FIG. 4, the foil 310 and the tool 320 are shown again, but in this drawing the foil 310 has been attached to the curve-shaped section of the tool 320 by means of a vacuum or generally, a low pressure. This process, in which the piece 310 is given the desired shape is known as vacuum forming.

Naturally, the foil 310 can be given its shape in other ways, such as being placed in a tool which is comprised of two parts, both of which have sections shaped in a desired way, and which are brought towards each other and thus also towards the piece 310. This procedure is known as form pressing, but the process known as injection moulding can also be used, and results in the section 322 of the piece 310 having the shape shown in FIG. 4, in other words the desired shape.

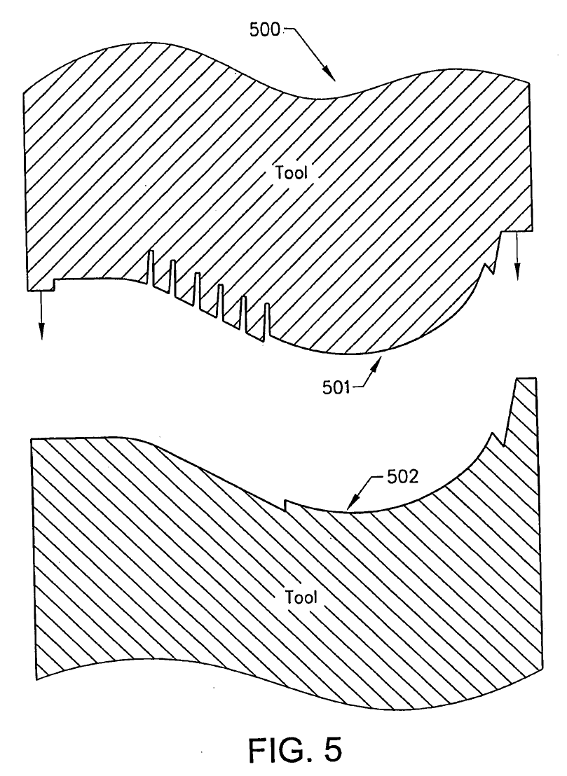

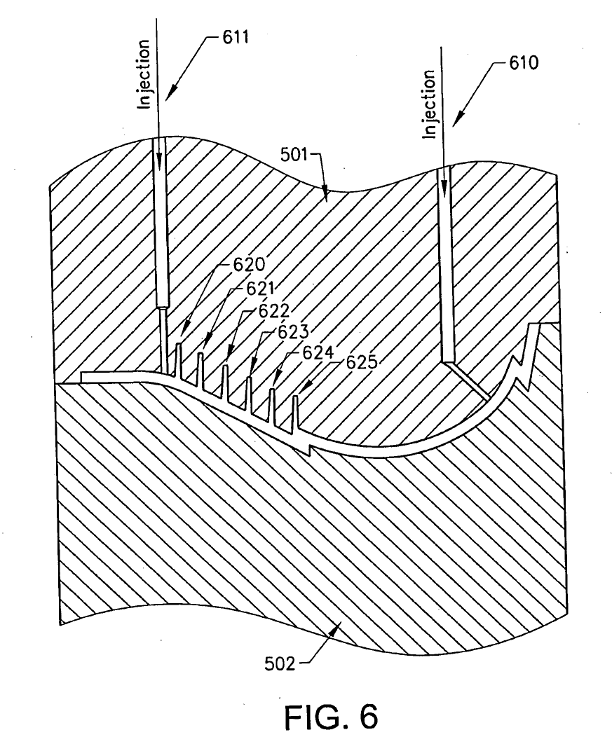

FIG. 5 shows a tool 500 for obtaining the carrier 230: The tool 500 comprises a first part 501, and a second part 502, both of which are shaped so that the carrier 230 will be given its desired shape, as will be shown later. In FIG. 6 the two parts 501 and 502 shown in FIG. 5 of the tool 500 are brought towards each other, and arranged so that a hollow space is left between the two parts, said hollow space essentially having the shape which is desired for the carrier 230. Also shown in FIG. 6 are two injection pipes 610, 611, and a plurality of protrusions 620-625 which protrude away from the hollow space.

The function of the protrusions 620-625 will be explained shortly. It can however be pointed out that the protrusions protrude in the direction of the future carrier 230 which will not face the driver of the car.

By means of the process known as “injection moulding”, the carrier 230 is formed in a thermoplastic polymer material, using the tool 500. The injection moulding process is well known as such, and will thus not be described in more detail here. However, the result of this process is that a carrier 230 in the desired form is obtained, by means of the thermoplastic polymer material being injected at high pressure through the injection pipes 610,611.

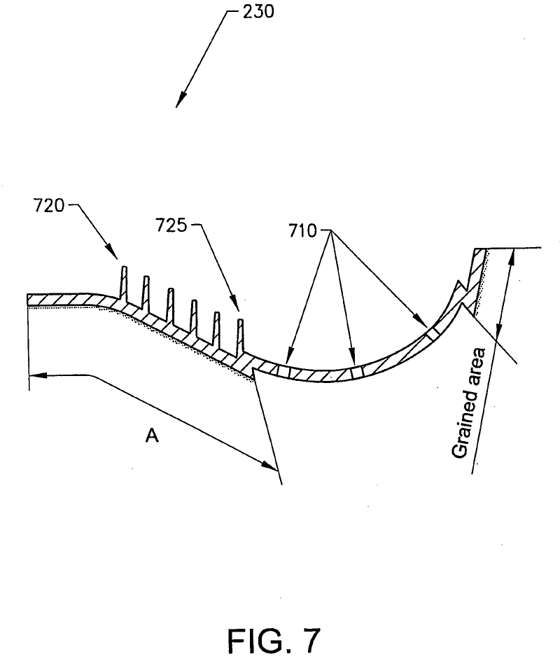

In FIG. 7, the carrier 230 is shown, having been removed from the tool 500. In the injection process, through-going holes 710 of a predetermined size and amount are formed in the carrier 230. This can be done during the injection moulding, or at a later stage. The reason for the holes 710 will become apparent later in this text.

As can be seen in FIG. 7, the carrier 230 comprises a number of “ribs” 720-725 which were formed by means of the protrusions 620-625 in FIG. 6. The reason for these protrusions will become evident later in this text. As can also be seen, at least one of the main surfaces of the carrier 230 can comprise a grained part A, said graining preferably being obtained in the tool 500.

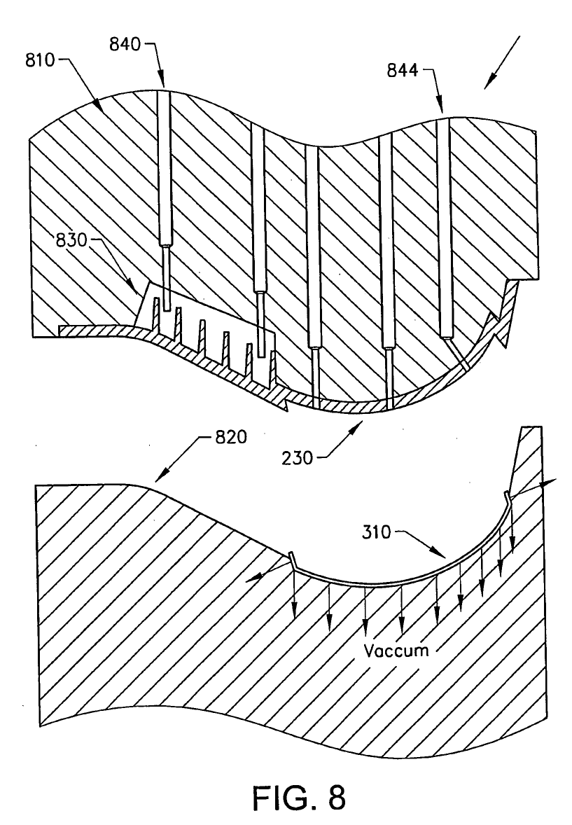

In FIG. 8, a tool 800 for forming the entire panel 200 is shown. It is in this tool 800 that the parts 230 and 210 are joined together, and the “cushion” that is covered by the material 210 is filled with a material of a third rigidity.

As shown in FIG. 8, the “joining tool” 800 also comprises a first 810 and a second 820 part. These two parts are arranged to give the trim panel the desired shape, in a manner which will be described in the following.

The cover 210 and the carrier 230 are placed between the first 810 and second 820 parts of the joining tool 800, the tool being arranged so that there will be a cavity in the tool between the cover and the carrier, or instead of a cavity, some other means for allowing the cushion to be formed.

Thus, the cover 210 and the carrier 230 are arranged in one part each of the tool 800, said parts being shaped so that the cover 210 and the carrier 230 can be received in a tight fit against the part. The cover 210 doesn't extend along the entire length of the carrier, which means that a certain length of the carrier, shown as 240 in FIG. 2, is left “exposed”, and will form the harder part of the trim panel 200.

The first part 810 of the tool 800 comprises a cavity 830 for receiving and enveloping the protrusions 620-625 of the carrier 230. The first part 810 of the toll also comprises a plurality 840-844 of straws or tubes for use in the injection moulding process, through which straws or tubes the foam will be injected.

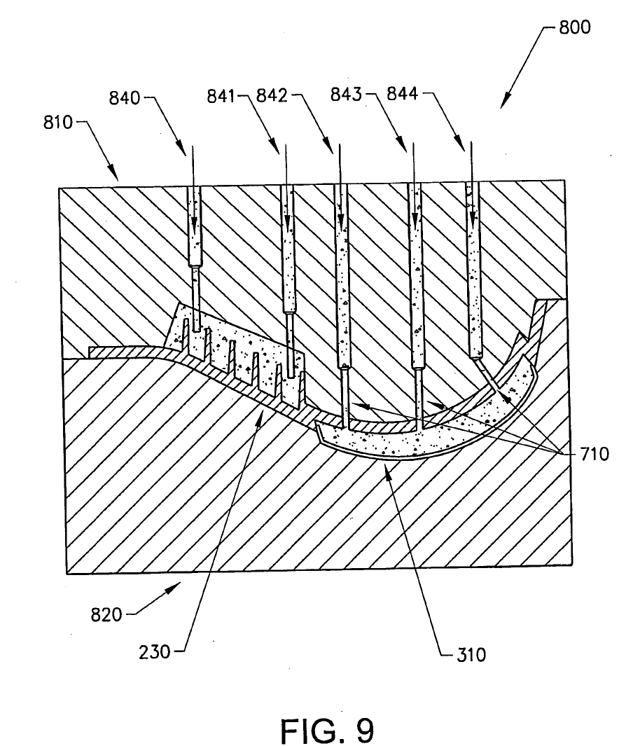

In FIG. 9, the tool 800 is shown again, in a position in which the two parts 810, 820, are brought towards each other, leaving a space between the foil 210 and the carrier 230, which space will be filled with a third material.

The reason for the through-going holes 710 which were formed in the carrier 230 in connection with the injection moulding shown in FIG. 7 will now become apparent: through these holes 710, as shown in FIG. 9, a foam is injected by means of the tubes or straws 840-844, which will give the cushion its desired shape. A suitable type of foam for this application is a PUR-foam, Polyurethane. The foam reaches the holes in the carrier via the tubes 840-844 through holes in the tool 800 which correspond to the holes 710 in the carrier 230, in a manner which as such is well known.

When the foam cures, it will act as a joining means between the cover foil 210 and the carrier 230. Apart from this, the foam will also combine with the foil or cover to give the cushion the desired elasticity or softness.

Turning now to that part 240 of the carrier 230 which will be exposed, a few things can be pointed out: in order to make this part of the carrier aesthetically pleasing, it may be painted or the surface may be given a pattern which enhances the aesthetic effect of the material used for the carrier 200. The pattern may be achieved by the process known as “graining”, which was also descried in connection with FIG. 7.

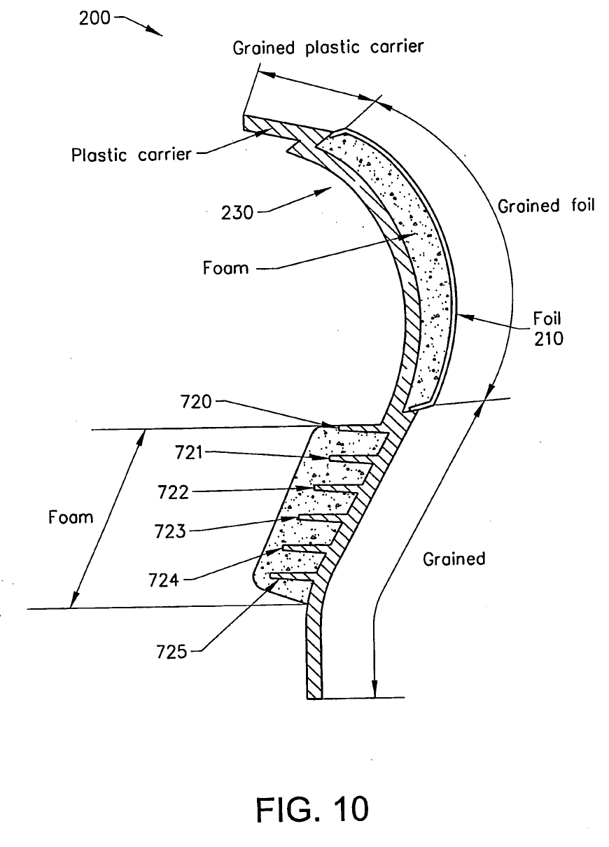

FIG. 10 shows the finished product, i.e. the panel 200, seen from the side. As can be seen, this is essentially the same view as that in FIG. 1, but with the addition of the structure of the ribs 720-725. This structure is not a necessary feature in a pane of the invention, rather, the panel with this structure can be seen as a second embodiment if the invention, which is used where the function of the ribs, which will be explained below, is needed.

As can be seen, the lattice of “ribs” 720-725 extends in one of the main directions A-B of the trim panel shown in FIG. 1, although they can also extend obliquely. In addition, the ribs can also have an extension which isn't totally straight, they can have a “step-like” shape. However, the structure or lattice is formed on that side of the panel which will face away from the user of the vehicle. As indicated in FIG. 10, the areas between ribs 720-725 will, in the production process shown previously, be filled with the foam used to fill the “cushion” of the panel.

The function of the ribs 720-725 is as follows: the ribs 720-725, together with the foam which fills the spaces between and around them, are a force-absorbing structure which will additionally enhance the safety aspects of the panel. The rib structure is located at a height of the panel where, if the panel is used as instrument panel, the driver's knees will encounter in the event of an accident. The rib structure will absorb at least part of the energy of the impact with the knees, and will thus prevent the panel from breaking open, which would harm the knees.

As has been seen above, the rib-structure shown in FIG. 10 can be obtained in essentially the same production process as the panel without these ribs, all that is needed is to alter the tools involved, and a panel with enhanced safety features is obtained.

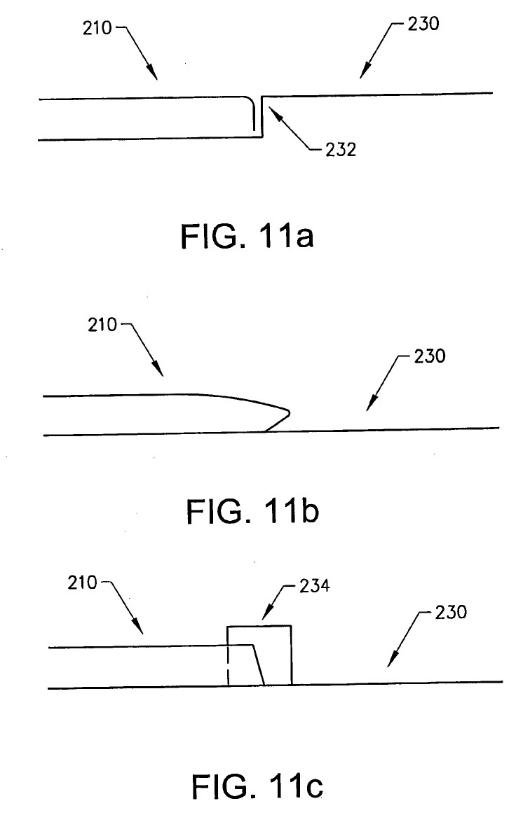

In FIG. 11a-11c, some different ways of obtaining a good transition between the foil 210 and the carrier 230 are shown. In FIG. 11a, a slight “step” 232 in the carrier is used, so that when the foil material 210 is placed against the carrier 230 in the joining tool, and the foam 220 is injected between the foil 210 and the carrier 230, at least one end of the cover 220 will be in contact with said step, thus ensuring a good transition between the cushion and the rest of the panel, i.e. the carrier 230.

In FIG. 11b, instead of a step in the carrier, the foil material 210 is folded backwards at its end, prior to the foam being injected, which will also ensure a good transition.

FIG. 11c shows a slightly different approach to the same problem, i.e. that of obtaining a good transition. In the embodiment shown in this drawing, the foil 210 has been placed “flat” against the carrier 230 in the joining tool.

In order to ensure that the transition is aesthetically pleasing, a covering trim detail 234 such as a strip of a decorative material has been placed over the transition.

1. A trim panel (100, 200) for the interior of the cab of a motor vehicle such as a truck, the trim panel having a first (A) and a second (B) main direction of extension, the trim panel comprising a first part (110, 240) and a second part (120, 210), the second part (210) being significantly less rigid than the first part in a direction which is essentially perpendicular towards at least one of said directions of extension, the panel (100,200) being characterized in that it comprises one continuous carrier (230) made in a first material with a certain first rigidity, with the first part (110, 240) being obtained by letting the carrier material be exposed and visible, and in that the second part (120, 210) is obtained by means of a second material (210) with a second rigidity covering a part of the carrier (230), the trim panel being further characterized in that there is a third material (220) with a third rigidity arranged between the first (230) and the second (210) material.

2. The trim panel (100,200) of claim 1, in which the materials with the first (230) and second (210) rigidity are joined to each other by means of the material (220) with the third rigidity.

3. The trim panel (700) of any of claims 1 or 2, additionally comprising a rib structure (720-725) of the first material on that side of the panel which is opposite to the side which comprises the second part, the space between at least two such ribs (720-725) being filled with the third material (220).

4. A process for manufacturing a trim panel (200, 700) for the interior of a motor vehicle, comprising the steps of:
having a carrier (230) in a first material with a first rigidity,
arranging on part of said carrier (230) a second material (210) with a second material,
filling a space between the second (210) and first (230) materials with a material (220) with a third rigidity,
the method being characterized in that the third material is a foam material (220), and in that the foam (220) is used to join the first (230) and second (210) materials to each other.

5. The manufacturing process of claim 4, additionally comprising the step of a creating a rib structure (720-725) of the first material on that side of the panel which is opposite to the side on which the second material is arranged, the space between at least two such ribs (720-725) being filled with the third material (220).
